(19) United States
(12) Patent Application Publication
(10) Pub. No.: US 2023/0315372 A1
(43) Pub. Date: Oct. 5, 2023

(54) CHARGE MANAGEMENT SYSTEM

(71) Applicant: HONDA MOTOR CO., LTD., Tokyo (JP)

(72) Inventor: Akira SAITA, Tokyo (JP)

(73) Assignee: HONDA MOTOR CO., LTD., Tokyo (JP)

(21) Appl. No.: 18/128,039

(22) Filed: Mar. 29, 2023

(30) Foreign Application Priority Data
Mar. 30, 2022 (JP) 2022-056585

(51) Int. Cl. G06F 3/14; G06T 3/40; G06T 11/00; G07C 5/08; G07C 5/00; H02J 7/00

(52) U.S. Cl. CPC G06F 3/14; G06T 3/40; G06T 11/001; G07C 5/0825; G07C 5/008; H02J 7/0048

(57) ABSTRACT

A battery charge management system for managing charge of a battery mounted on a moving object includes processing circuitry configured to: cause a display unit to display a SOC image of the battery; acquire power consumption history of the battery; and estimate a SOC consumption amount consumed in one day based on the power consumption history. The processing circuitry allocates one segment of the SOC image displayed on the display unit to the SOC consumption amount consumed in one day, and the processing circuitry causes the display unit to display the SOC image and a remaining number of days to a threshold SOC.

### CROSS-REFERENCE TO RELATED APPLICATIONS

This application is based on and claims priority under 35 USC 119 from Japanese Patent Application No. 2022-056585 filed on Mar. 30, 2022, the entire content of which is incorporated herein by reference.

### TECHNICAL FIELD

The present invention relates to a charge management system mounted on a moving object.

### BACKGROUND ART

in recent years, research and development on electric vehicles that contribute to improvement in energy efficiency have been carried out to secure access to affordable, reliable, sustainable, and modern energy for more people.

Incidentally, when managing a remaining battery capacity of an electric vehicle on which a high-capacity battery is mounted, it is common that from a user psychology to save a trouble of a charge count, as compared with a case where a battery is always connected to a charger at the time of returning home, remaining battery capacity display is checked on a daily basis, and a user determines that it is better to charge the battery soon in consideration of a scheduled travel distance from now on, and charges the battery.

Therefore, regarding the remaining battery capacity display, it is necessary to intuitively display the time to charge for the user in an easy-to-understand manner. For example, JP2013-207847A discloses that at least one of a control target value and a change prediction value of a state of charge (SOC) is displayed on a display unit based on a predicted travel route and a learned charge/discharge amount. Further, JP2016-155399A discloses that indicator display is changed for each of an EV travel mode and an HV travel mode.

However, in the related-art technique, there is room for improvement in terms of intuitively displaying the time to charge for the user in an easy-to-understand manner.

An aspect of the present disclosure relates to provide a charge management system that intuitively displays time to charge for a user in an easy-to-understand manner. The present invention contributes to the improvement in the energy efficiency.

### SUMMARY OF INVENTION

According to an aspect of the present disclosure, there is provided a battery charge management system for managing charge of a battery mounted on a moving object, the battery charge management system including processing circuitry configured to: cause a display unit to display a SOC image of the battery; acquire power consumption history of the battery; and estimate a SOC consumption amount consumed in one day based on the power consumption history. The processing circuitry allocates one segment of the SOC image displayed on the display unit to the SOC consumption amount consumed in one day, and causes the display unit to display the SOC image and a remaining number of days to a threshold SOC.

According to another aspect of the present disclosure, there is provided a battery charge management system for managing charge of a battery mounted on a moving object, the battery charge management system including a processing circuitry configured to: cause a display unit to display a SOC image of the battery; acquire power consumption history of the battery; and estimate a SOC consumption amount consumed in a unit period based on the power consumption history. The processing circuitry allocates one segment of the SOC image displayed on the display unit to the SOC consumption amount consumed in the unit period, and causes the display unit to display the SOC image and a remaining unit period to a threshold SOC.

According to still another aspect of the present disclosure, there is provided a battery charge management system for managing charge of a battery mounted on a moving object, the battery charge management system including a processing circuitry configured to: cause a display unit to display a SOC image of the battery; acquire power consumption history of the battery; and estimate a SOC consumption amount consumed at one time based on the power consumption history. The processing circuitry allocates one segment of the SOC image displayed on the display unit to a SOC consumption amount consumed in the one travel, and causes the display unit to display the SOC image and a remaining count to a threshold SOC.

### BRIEF DESCRIPTION OF DRAWINGS

FIG. 1 is a diagram showing a relationship among a vehicle 1 on which a battery 11 is mounted, a management server 2 that constitutes a charge management system 21, and a portable terminal 3 of a user;

FIG. 2 is a block diagram of the charge management system 21;

FIG. 3 is a diagram showing battery charge information displayed on the portable terminal 3 of the user:

FIG. 4 is a diagram illustrating a SOC image;

FIG. 5 is a diagram showing a charge recommendation notification displayed on the portable terminal 3 of the user:

FIG. 6 is a flowchart of registration of power consumption history;

FIG. 7 is a flowchart of generation of the SOC image;

FIG. 8 is a flowchart of execution of the charge recommendation notification;

FIG. 9 is a block diagram of the charge management system 21 according to a modification:

FIG. 10 is a diagram showing the battery charge information displayed on the portable terminal 3 of the user in an enlarged manner:

FIG. 11 is a diagram showing battery charge information displayed on the portable terminal 3 of the user in a first modification in which an estimated ASOC is not a constant value;

FIG. 12 is a diagram showing battery charge information displayed on the portable terminal 3 of the user in a second modification in which one segment (one scale) of the SOC image indicates one week; and

FIG. 13 is a diagram showing battery charge information displayed on the portable terminal 3 of the user in the second modification in which one segment (one scale) of the SOC image indicates a travel count.

### DESCRIPTION OF EMBODIMENTS

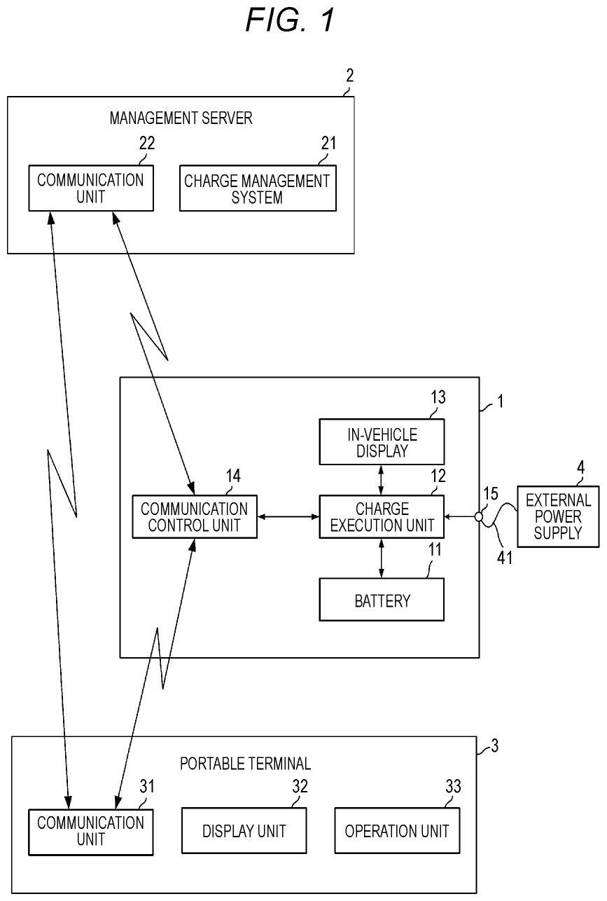

Hereinafter, an embodiment of the present invention will be described with reference to FIGS. 1 to 8.

FIG. 1 is a diagram showing a relationship among a vehicle 1 on which a battery 11 is mounted, a management server 2 that constitutes a charge management system 21, and a portable terminal 3 of a user. In the present embodiment, the charge management system 21 is mounted on the management server 2, but the charge management system 21 may be mounted on the vehicle 1 or the portable terminal 3, or may be dispersedly mounted on the vehicle 1, the management server 2, and the portable terminal 3.

In the present embodiment, the vehicle may be any vehicle as long as the vehicle can be moved by a power supply from a battery. Therefore, the present embodiment can be applied to various vehicles such as a two-wheeled vehicle, a three-wheeled vehicle, and a four-wheeled vehicle. The vehicle includes an electric vehicle that travels by a power supply from a battery, and a hybrid vehicle including a motor that performs driving by receiving the power supply from the battery and an internal combustion engine.

As shown in FIG. 1, the vehicle 1 includes a battery 11, a charge execution unit 12, an in-vehicle display 13, a communication control unit 14, and a charge port 15. An external power supply 4 is, for example, charge equipment installed in a site of home of the user of the vehicle 1. When the vehicle 1 is on the site, the user establishes a state where charge from the external power supply 4 to the battery 11 is enabled by inserting a charge connector (charge gun) provided at a tip end of a cable 41 that extends from the external power supply 4 into the charge port 15. In the present embodiment, a case where the battery 11 is charged from the external power supply 4 by the plug-in method has been described, but the battery 11 may be charged from the external power supply 4 by a non-contact power supply method.

When the charge connector is connected to the charge port 15, the charge execution unit 12 executes charge from the external power supply 4 to the battery 11 according to control from the management server 2. Further, the charge execution unit 12 can acquire various pieces of information on the vehicle 1 including the battery 11 (for example, a state of charge (SOC) that is a remaining capacity of the battery 11, a temperature of the battery 11 (hereinafter, referred to as a battery temperature)), and an outside air temperature of the vehicle 1 by using various sensors.

The in-vehicle display 13 is a navigation device or the like provided in the vehicle 1. Therefore, the in-vehicle display 13 can display the various pieces of information as images and output the information as sound. Further, the in-vehicle display 13 includes an operation unit such as a touch panel that receives an operation input from the user.

The communication control unit 14 can transmit and receive information to and from the management server 2 and the portable terminal 3 by wireless communication. For example, the communication control unit 14 receives an instruction content related to charge control of the battery 11 from the management server 2 and outputs the instruction content to the charge execution unit 12, and transmits various pieces of information on the battery 11 acquired by the charge execution unit 12 to the management server 2.

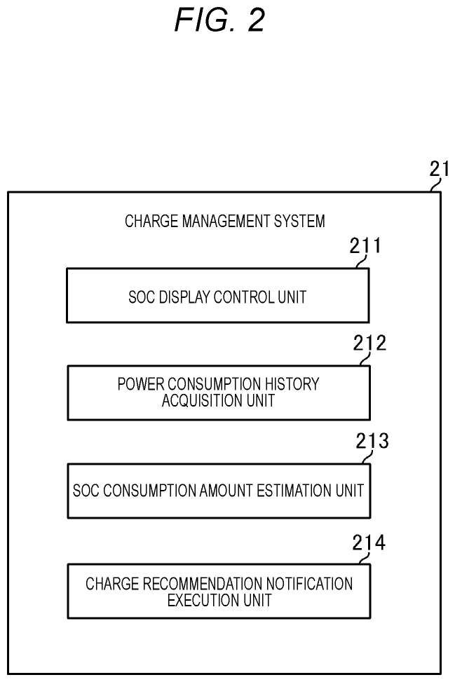

The management server 2 includes the charge management system 21 and a communication unit 22. The charge management system 21 includes hardware including a control processor such as a CPU and a storage device such as a ROM, a RAM, and storage, and software such as a charge management program stored in the ROM or the storage. As shown in FIG. 2, the charge management system 21 includes a SOC display control unit 211, a power consumption history acquisition unit 212, a SOC consumption amount estimation unit 213, and a charge recommendation notification execution unit 214 as functional configurations implemented by cooperation between the hardware and the software. These functional configurations will be described later.

The communication unit 22 can transmit and receive information to and from the communication control unit 14 of the vehicle 1 and the portable terminal 3 by the wireless communication. For example, the communication unit 22 receives the various pieces of information on the vehicle 1 (for example, the SOC of the battery 11, the battery temperature, and the outside air temperature of the vehicle 1) from the communication control unit 14.

The portable terminal 3 is, for example, a smart device such as a smartphone, smart glasses, or a smartwatch, and includes a communication unit 31, a display unit 32, and an operation unit 33. The communication unit 31 can transmit and receive information to and from the communication unit 22 of the management server 2 and the communication control unit 14 of the vehicle 1 by the wireless communication. The display unit 32 displays various pieces of information as images. The operation unit 33 is a touch panel or the like that receives an operation input from the user.

Next, functional configurations of the charge management system 21 will be described.

The power consumption history acquisition unit 212 acquires power consumption history of the battery 11. For example, a SOC at the time of departing from home and a SOC at the time of returning home are acquired from the charge execution unit 12 of the vehicle 1, a SOC consumption amount (%/day) used in one day (hereinafter, referred to as ASOC as appropriate) is calculated from a difference thereof, and the ASOC is registered in the storage unit in association with date data.

Based on the power consumption history, the SOC consumption amount estimation unit 213 estimates a SOC consumption amount consumed in one day on or after the next day (hereinafter, referred to as an estimated ASOC as appropriate). For example, the estimated ASOC on or after the next day is calculated by statistical estimation based on the power consumption history. The estimated ASOC is, for example, an average value of ASOC in a predetermined period such as a past week.

The SOC display control unit 211 causes the in-vehicle display 13 or the portable terminal 3 to display a SOC image of the battery 11. At this time, the SOC display control unit 211 allocates (assigns) one segment (one scale) of the SOC image to be displayed to the estimated ASOC, and causes the SOC image and remaining number of days from a threshold SOC to be displayed. Specifically, the SOC display control unit 211 causes the SOC image in which the remaining number of days to the threshold SOC is displayed by dividing the SOC image to each day, and remaining number of days that is text data to be displayed. The threshold SOC may be a threshold for performing a charge recommendation notification described later, may be a lower limit value (for example, 0%) of the SOC, or may be a set value set to prevent deterioration of the battery 11. In the following description, the threshold SOC will be described as the threshold for performing the charge recommendation notification.

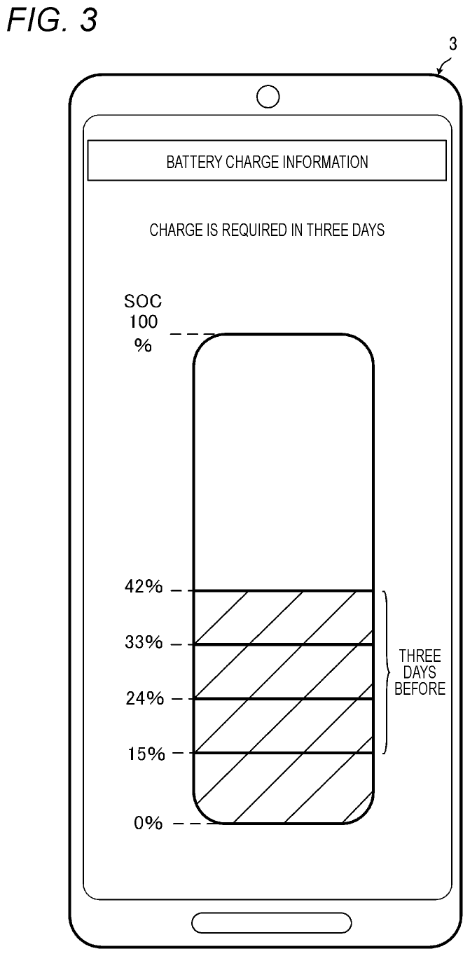

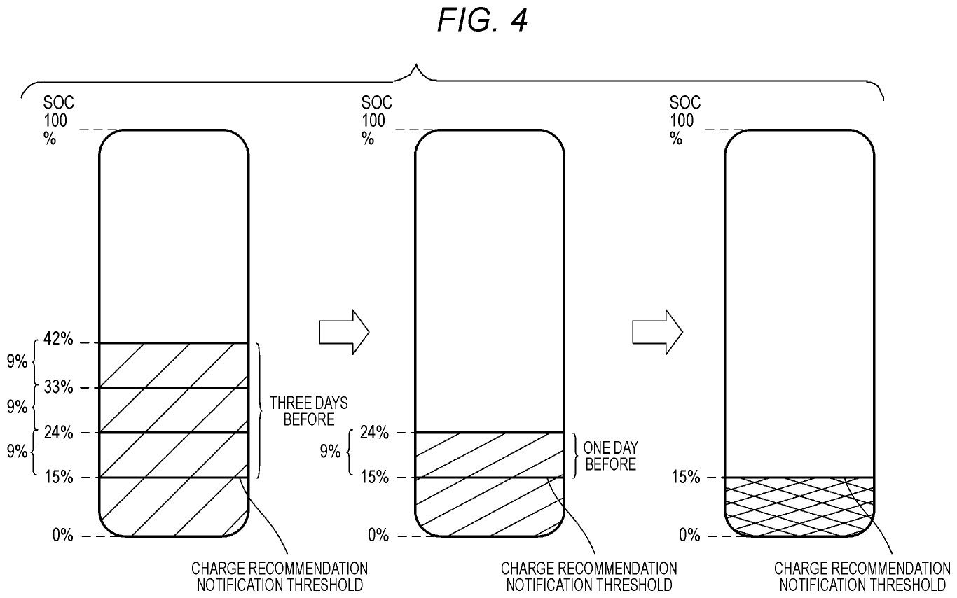

FIG. 3 is a diagram showing battery charge information displayed on the portable terminal 3 of the user. FIG. 4 is a diagram illustrating the SOC image. In examples shown in FIGS. 3 and 4, the estimated ASOC estimated by the SOC consumption amount estimation unit 213 is 9%, and the threshold SOC is set to 15%. The SOC display control unit 211 allocates one segment (one scale) of the SOC image to 9% that is the estimated ASOC, and accumulates 9% at a time from 15% that is the threshold SOC to display a current SOC (42% in the example of FIG. 3). In the SOC image, the current SOC is divided by day (every 9%). Further, the SOC display control unit 211 displays the remaining number of days in text data (“three days ago” in the example of FIG. 3). Display related to the remaining number of days may include the remaining number of days. Accordingly, the user can intuitively know time to charge.

The SOC display control unit 211 preferably changes a SOC image color according to the remaining number of days. Referring to FIG. 4, for example, the SOC display control unit 211 displays the SOC image in green when the remaining number of days is two days or more (see a left side of FIG. 4), displays the SOC image in yellow when the remaining number of days is one day (see a middle of FIG. 4), and displays the SOC image in red when the remaining number of days is zero day (see a right side of FIG. 4). Accordingly, the user can more intuitively know the time to charge. The color of the SOC image can be appropriately set.

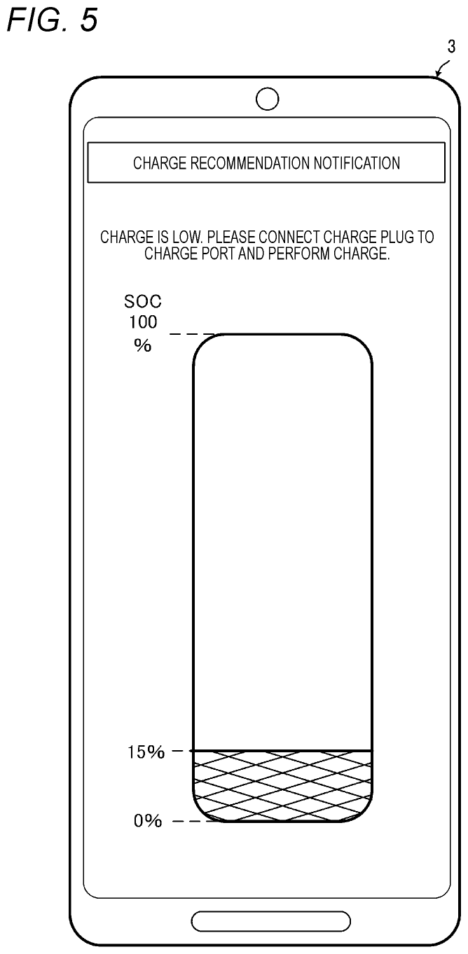

When the vehicle 1 arrives at a pre-registered charge place (for example, home) and the current SOC is equal to or smaller than the threshold SOC, the charge recommendation notification execution unit 214 causes the in-vehicle display 13 or the portable terminal 3 to display the charge recommendation notification. FIG. 5 is a diagram showing the charge recommendation notification displayed on the portable terminal 3 of the user. Accordingly, the user can be prevented from forgetting charging. It is preferable that the threshold SOC for performing the charge recommendation notification can be freely set by the user. In this way, an intention of the user can be reflected in the threshold SOC for performing the charge recommendation notification. The threshold SOC for performing the charge recommendation notification may be a specified value, or may be set based on the power consumption history by the charge management system 21. In the example of FIG. 5, for example, a text message saying that “Charge is low. Please connect charge plug to charge port and perform charge” is displayed together with the SOC image.

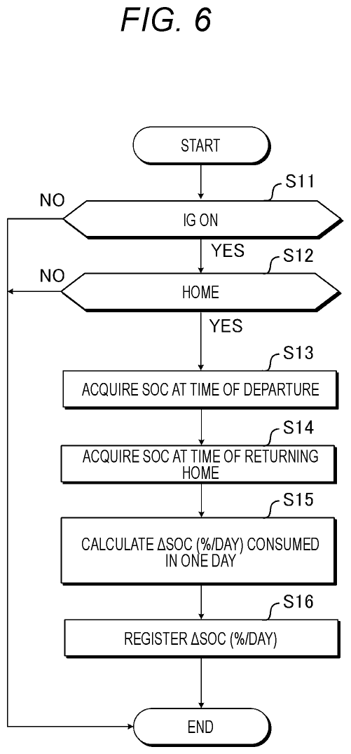

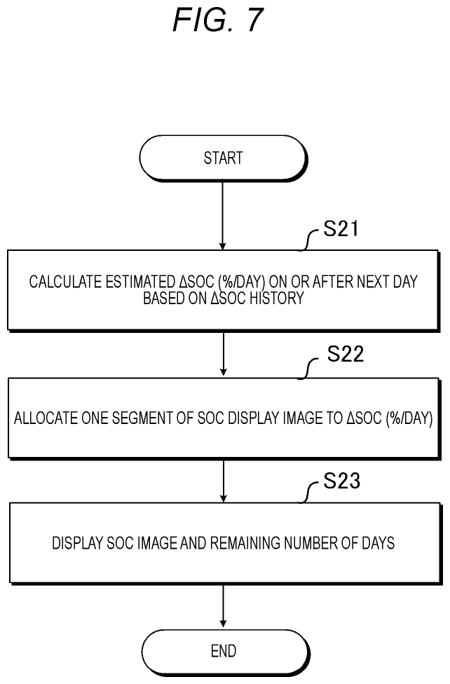

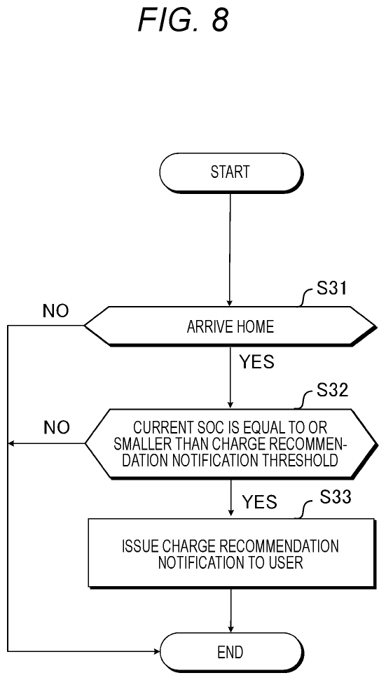

Next, a specific process procedure of the charge management system 21 will be described with reference to FIGS. 6 to 8. FIG. 6 is a flowchart of registration of the power consumption history. FIG. 7 is a flowchart of generation of the SOC image. FIG. 8 is a flowchart of execution of the charge recommendation notification.

In the registration of the power consumption history shown in FIG. 6, the charge management system 21 determines whether an ignition switch of the vehicle 1 is ON (S11), and determines whether a position of the vehicle 1 is home (S12). When any one of determination results is NO, the charge management system 21 ends the process. When both the determination results in steps S1 and S12 are YES, the charge management system 21 acquires a SOC at the time of departure (S13). Further, the charge management system 21 acquires a SOC at the time of returning home during home-returning (S14). The charge management system 21 calculates a ASOC (%/day) consumed in one day (S15), and registers the calculated ASOC in the storage unit in association with the date data (S16).

In the generation of the SOC image shown in FIG. 7, the charge management system 21 calculates an estimated ASOC (%/day) on or after the next day based on the power consumption history (S21), and allocates one segment of the SOC image to the estimated ASOC (S22). Thereafter, the charge management system 21 causes the in-vehicle display 13 or the portable terminal 3 to display a screen (see FIG. 3) including the remaining number of days before the charge and the SOC image (S23). A timing at which the battery charge information is displayed may be triggered by an input operation of the user, may be triggered by ON of the ignition switch, or may be preset by the user. For example, the user may set the timing such that the portable terminal 3 of the user receives the screen at fixed time each day, or may set the timing such that the portable terminal 3 of the user receives the screen n days before (n>1) a day on which notification of the charge recommendation notification is assumed.

In the execution of the charge recommendation notification shown in FIG. 8, the charge management system 21 determines whether the vehicle arrives home (S31), and determines whether the current SOC is equal to or smaller than a charge recommendation notification threshold (S32). When any one of determination results is NO, the charge management system 21 ends the process. When both the determination results in steps S31 and S32 are YES, the charge management system 21 issues the charge recommendation notification (see FIG. 5) to the portable terminal 3 of the user (S33). A power reception recommendation notification can also be issued to the in-vehicle display 13.

Although various embodiments have been described above with reference to the drawings, it is needless to say that the present invention is not limited to these examples. It will be apparent to those skilled in the art that various changes and modifications may be conceived within the scope of the claims. It is also understood that the various changes and modifications belong to the technical scope of the present invention. Further, the constituent elements in the embodiments described above may be combined freely within a range not departing from the spirit of the invention.

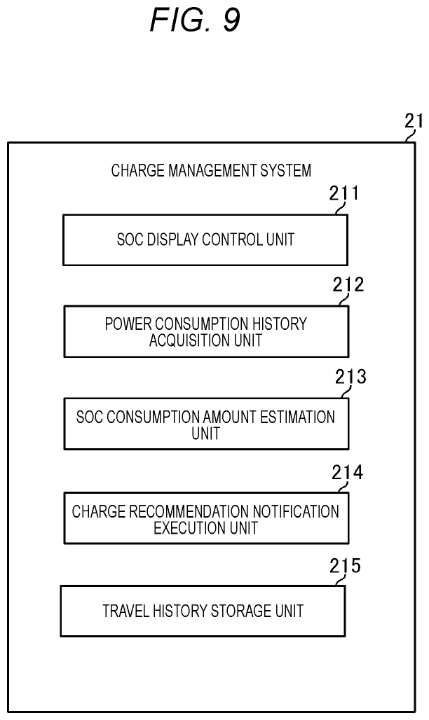

For example, as shown in FIG. 9, the charge management system 21 may further include a travel history storage unit 215 that stores travel history of the vehicle 1, and the power consumption history acquisition unit 212 may acquire the power consumption history based on the travel history. In this way, the power consumption history of the battery 11 can be estimated based on the travel history without necessarily storing the power consumption history of the battery 11.

The SOC display control unit 211 may cause the SOC image to be displayed in an enlarged manner by changing a SOC upper limit value of the SOC image displayed on the in-vehicle display 13 or the portable terminal 3 based on the power consumption history. That is, in a SOC image in which the SOC upper limit value of the SOC image is set to 100%, there is a risk that the user may be excessively uneasy when the SOC decreases, but it is possible to reduce the risk that the user may be excessively uneasy when the SOC decreases by displaying the SOC image in an enlarged manner by changing the SOC upper limit value of the SOC image.

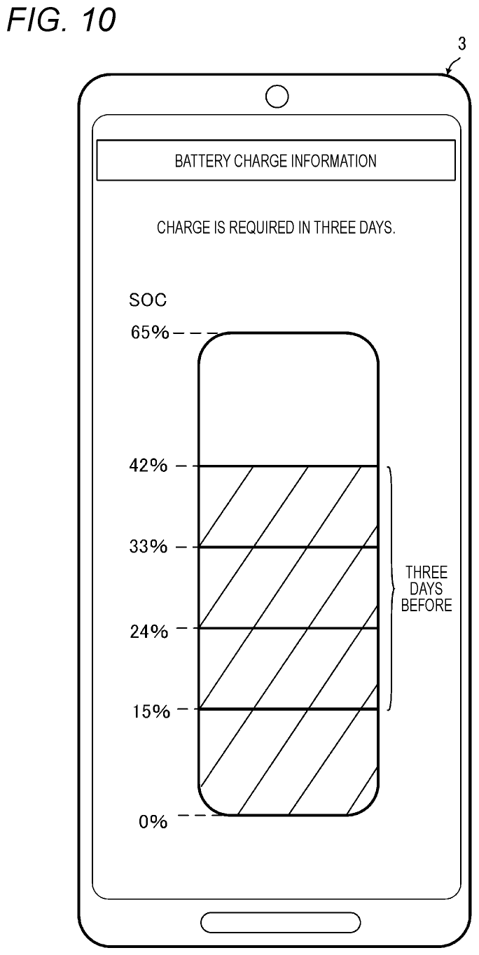

FIG. 10 is a diagram showing battery charge information in which the SOC upper limit value of the SOC image is changed and which is displayed on the in-vehicle display 13. In FIG. 10, the SOC upper limit value is changed to 65% instead of 100%, and the SOC image is displayed in an enlarged manner. It is desirable that the SOC upper limit value in a case of the enlargement is set as a maximum value of the SOC consumption amount (ASOC) consumed in one day in a predetermined period in the past. The predetermined period is, for example, a past week. In this way, even if the SOC decreases, the user can intuitively grasp how much remaining battery capacity remains relative to away of use of the user him/herself.

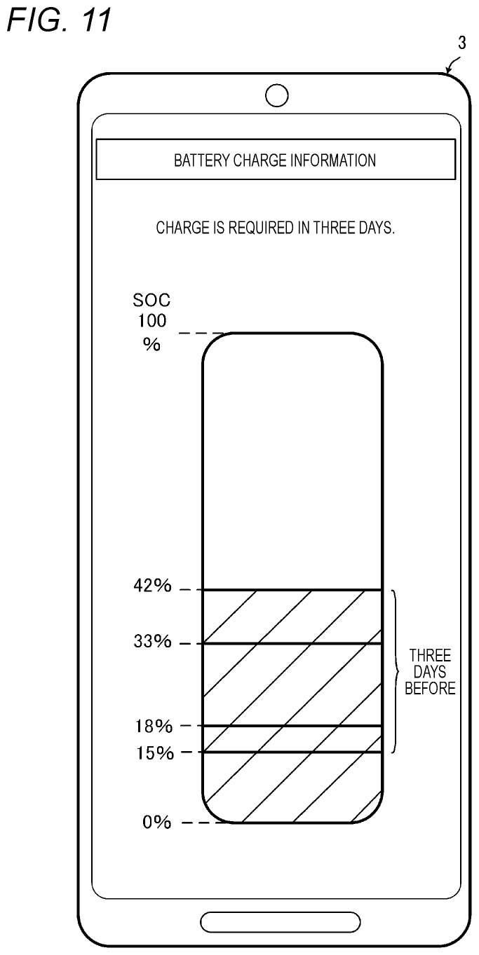

In the embodiment described above, the estimated ASOC that is the SOC consumption amount consumed in one day on or after the next day is a constant value (9% in FIG. 4), but the estimated ASOC is not necessarily a constant value. For example, a SOC consumption amount (estimated ASOC) consumed for each day of the week may be calculated. Further, the SOC consumption amount (estimated ASOC) may be calculated not only for each day of the week but also on weekdays and holidays. FIG. 11 is a diagram showing battery charge information displayed on the portable terminal 3 of the user in a first modification in which the estimated ASOC is not a constant value.

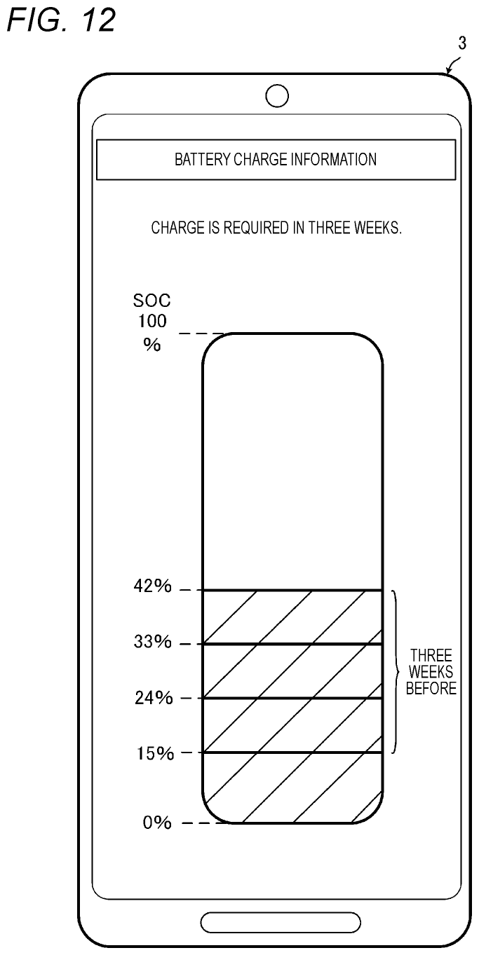

In the embodiment described above, one segment (one scale) of the displayed SOC image indicates one day, but the one segment is not limited to one day, and may be one week or one month, and a unit period is not limited. FIG. 12 is a diagram showing battery charge information displayed on the portable terminal 3 of the user in a second modification in which one segment (one scale) of the SOC image indicates one week. In this case, the SOC display control unit 211 causes a SOC image in which one segment (one scale) of the displayed SOC image is set as an estimated ASOC consumed in one week and remaining number of weeks (three weeks before) from the threshold SOC to be displayed.

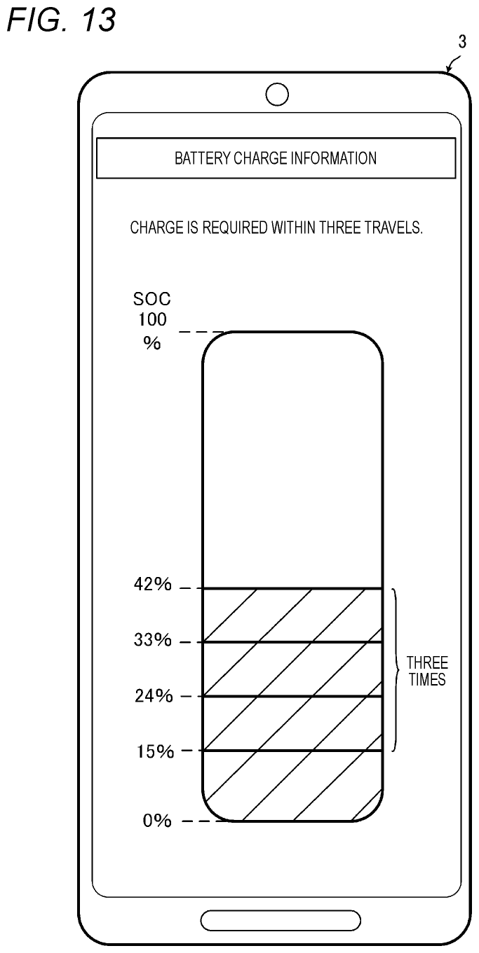

In the embodiment described above, one segment (one scale) of the displayed SOC image indicates one day, but the one segment is not limited to a period, and may be a travel count. FIG. 13 is a diagram showing battery charge information displayed on the portable terminal 3 of the user in a third modification in which one segment (one scale) of the SOC image indicates the travel count. In this case, the SOC display control unit 211 causes a SOC image in which one segment (one scale) of the displayed SOC image is set as an estimated ASOC consumed in one travel and a remaining travel count (three times) to the threshold SOC to be displayed.

In the embodiment described above, the vehicle 1 has been exemplified as the moving object, but the moving object is not limited to the vehicle, and may be a flying object such as a drone or a work machine such as a lawn mower.

The in-vehicle display 13 and the portable terminal 3 have been exemplified as the display units, but are not limited thereto, and may be a HEMS display or an in-vehicle display corresponding to virtual reality (VR)/augmented reality (AR).

In the present specification, at least the following matters are described. Although corresponding constituent elements or the like in the above-described embodiment are shown in parentheses, the present invention is not limited thereto.

(1) A battery charge management system (the charge management system 21) for managing charge of a battery (the battery 11) mounted on a moving object (the vehicle 1), the battery charge management system including:
a SOC display control unit (the SOC display control unit 211) configured to cause a display unit (the in-vehicle display 13 or the portable terminal 3) to display a SOC image of the battery;
a power consumption history acquisition unit (the power consumption history acquisition unit 212) configured to acquire power consumption history of the battery; and a SOC consumption amount estimation unit (the SOC consumption amount estimation unit 213) configured to estimate a SOC consumption amount consumed in one day based on the power consumption history,
in which the SOC display control unit allocates one segment of the SOC image displayed on the display unit to the SOC consumption amount consumed in one day, and
in which the SOC display control unit causes the display unit to display the SOC image and a remaining number of days to a threshold SOC.

According to (1), the one segment of the SOC image indicates the SOC consumption amount of the battery consumed in one day, and the SOC image and the remaining number of days are displayed on the display unit, so that a user can intuitively know time to charge.

(2) The charge management system according to (1),
in which the SOC display control unit displays the remaining number of days to the threshold SOC by dividing the SOC image to each day.

According to (2), since the remaining number of days is displayed in the SOC image divided to each day, the user can more intuitively know the time to charge.

(3) The charge management system according to (1) or (2),
in which the SOC display control unit changes a color of the SOC image according to the remaining number of days.

According to (3), since the color of the SOC image is changed according to the remaining number of days, the user can more intuitively know the time to charge.

(4) The charge management system according to any one of (1) to (3),
in which the threshold SOC is a threshold that is able to be set by a user and that is for issuing a charge recommendation notification.

According to (4), it is possible to grasp the remaining number of days before a day on which the charge recommendation notification is notified. Further, since the charge recommendation notification can be set by the user, an intention of the user can be reflected.

(5) The charge management system according to any one of (1) to (4),
in which the SOC display control unit causes the SOC image to be displayed in an enlarged manner by changing a SOC upper limit value of the SOC image displayed on the display unit based on the power consumption history.

According to (5), in a SOC image in which the upper limit value of the SOC image is set to SOC 100%, there is a risk that the user may be excessively uneasy when a SOC decreases, but it is possible to reduce the risk that the user may be excessively uneasy when the SOC decreases by displaying the SOC image in an enlarged manner by changing the SOC upper limit value of the SOC image.

(6) The charge management system according to (5),
in which the SOC upper limit value of the SOC image is a maximum value of a SOC consumption amount consumed in one day in a predetermined period in past.

According to (6), since the SOC upper limit value is the maximum value of the SOC consumption amount consumed in one day in the predetermined period in the past, even if the SOC decreases, the user can intuitively grasp how much remaining battery capacity remains relative to a way of use of the user him/herself.

(7) The charge management system according to any one of (1) to (6), further including:
a travel history storage unit (the travel history storage unit 215) configured to store travel history of the moving object,
in which the power consumption history acquisition unit acquires the power consumption history based on the travel history.

According to (7), it is possible to acquire the power consumption history based on the travel history even if the power consumption history is not necessarily stored.

(8) The charge management system according to any one of (1) to (7), further including:
a charge recommendation notification execution unit (the charge recommendation notification execution unit 214) configured to issue a charge recommendation notification,
in which when the moving object arrives at a pre-registered charge place and a current SOC is equal to or smaller than a threshold for issuing the charge recommendation notification, the charge recommendation notification execution unit issues the charge recommendation notification to the display unit.

According to (8), the user can be prevented from forgetting charging.

(9) The charge management system according to (8),
in which the display unit is at least one of an in-vehicle display (the in-vehicle display 13) and a portable terminal (the portable terminal 3) of a user.

According to (9), since the charge recommendation notification is issued to at least one of the in-vehicle display and the portable terminal of the user, the user can be prevented from forgetting charging.

(10) A battery charge management system (the charge management system 21) for managing charge of a battery (the battery 11) mounted on a moving object (the vehicle 1), the battery charge management system including:
a SOC display control unit (the SOC display control unit 211) configured to cause a display unit (the in-vehicle display 13 or the portable terminal 3) to display a SOC image of the battery;
a power consumption history acquisition unit (the power consumption history acquisition unit 212) configured to acquire power consumption history of the battery; and
a SOC consumption amount estimation unit (the SOC consumption amount estimation unit 213) configured to estimate a SOC consumption amount consumed in a unit period based on the power consumption history,
in which the SOC display control unit allocates one segment of the SOC image displayed on the display unit to the SOC consumption amount consumed in the unit period, and
in which the SOC display control unit causes the display unit to display the SOC image and a remaining unit period to a threshold SOC.

According to (10), the one segment of the SOC image indicates the SOC consumption amount of the battery consumed in the unit period, and the SOC image and the remaining unit period are displayed on the display unit, so that the user can intuitively know the time to charge.

(11) A battery charge management system (the charge management system 21) for managing charge of a battery (the battery 11) mounted on a moving object (the vehicle 1), the battery charge management system including:
a SOC display control unit (the SOC display control unit 211) configured to cause a display unit (the in-vehicle display 13 or the portable terminal 3) to display a SOC image of the battery;
a power consumption history acquisition unit (the power consumption history acquisition unit 212) configured to acquire power consumption history of the battery; and
a SOC consumption amount estimation unit (the SOC consumption amount estimation unit 213) configured to estimate a SOC consumption amount consumed at one time based on the power consumption history,
in which the SOC display control unit allocates one segment of the SOC image displayed on the display unit to a SOC consumption amount consumed in the one travel, and
in which the SOC display control unit causes the display unit to display the SOC image and a remaining count to a threshold SOC.

According to (11), the one segment of the SOC image indicates the SOC consumption amount of the battery consumed at one time, and the SOC image and the remaining count are displayed on the display unit, so that the user can intuitively know the time to charge.

What is claimed is:

1. A battery charge management system for managing charge of a battery mounted on a moving object, the battery charge management system comprising processing circuitry configured to:
cause a display unit to display a SOC image of the battery;
acquire power consumption history of the battery; and
estimate a SOC consumption amount consumed in one day based on the power consumption history,
wherein the processing circuitry allocates one segment of the SOC image displayed on the display unit to the SOC consumption amount consumed in one day, and
wherein the processing circuitry causes the display unit to display the SOC image and a remaining number of days to a threshold SOC.

2. The charge management system according to claim 1,
wherein the processing circuitry displays the remaining number of days to the threshold SOC by dividing the SOC image to each day.

3. The charge management system according to claim 1,
wherein the processing circuitry changes a color of the SOC image according to the remaining number of days.

4. The charge management system according to claim 1,
wherein the threshold SOC is a threshold that is able to be set by a user and that is for issuing a charge recommendation notification.

5. The charge management system according to claim 1,
wherein the processing circuitry causes the SOC image to be displayed in an enlarged manner by changing a SOC upper limit value of the SOC image displayed on the display unit based on the power consumption history.

6. The charge management system according to claim 5,
wherein the SOC upper limit value of the SOC image is a maximum value of a SOC consumption amount consumed in one day in a predetermined period in past.

7. The charge management system according to claim 1, wherein
the processing circuitry is further configured to store travel history of the moving object,
wherein the processing circuitry acquires the power consumption history based on the travel history.

8. The charge management system according to claim 1, wherein
the processing circuitry is further configured to issue a charge recommendation notification,
wherein when the moving object arrives at a pre-registered charge place and a current SOC is equal to or smaller than a threshold for issuing the charge recommendation notification, the processing circuitry issues the charge recommendation notification to the display unit.

9. The charge management system according to claim 8,
wherein the display unit is at least one of an in-vehicle display and a portable terminal of a user.

10. A battery charge management system for managing charge of a battery mounted on a moving object, the battery charge management system comprising a processing circuitry configured to:
cause a display unit to display a SOC image of the battery,
acquire power consumption history of the battery; and
estimate a SOC consumption amount consumed in a unit period based on the power consumption history,
wherein the processing circuitry allocates one segment of the SOC image displayed on the display unit to the SOC consumption amount consumed in the unit period, and
wherein the processing circuitry causes the display unit to display the SOC image and a remaining unit period to a threshold SOC.

11. A battery charge management system for managing charge of a battery mounted on a moving object, the battery charge management system comprising a processing circuitry configured to:
cause a display unit to display a SOC image of the battery;
acquire power consumption history of the battery; and
estimate a SOC consumption amount consumed at one time based on the power consumption history,
wherein the processing circuitry allocates one segment of the SOC image displayed on the display unit to a SOC consumption amount consumed in the one travel, and
wherein the processing circuitry causes the display unit to display the SOC image and a remaining count to a threshold SOC.
